(19) United States
(12) Patent Application Publication
(10) Pub. No.: US 2007/0143325 A1
(43) Pub. Date: Jun. 21, 2007

(54) Method and system of marketing using effectiveness metrics

(75) Inventor: Walter E. Head, Metamora, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/305,186

(22) Filed: Dec. 19, 2005

(51) Int. Cl. G06F 7/00

(52) U.S. Cl. 707/101

(57) ABSTRACT

A system of marketing using effectiveness metrics includes a server hosting an internet application, a database capable of storing information received by the server, and a digital storage medium providing a user interface when inserted into a client device. The user interface includes at least one link to the internet application, a user being directed to the internet application by the link in the user interface and interacting with the internet application using the client device. Information relating to the user is transmitted and stored in the database. The internet application is changed based on an analysis of the transmitted information.

### TECHNICAL FIELD

The present disclosure relates generally to a method and system of marketing, and more particularly, to a method and system of marketing using effectiveness metrics.

### BACKGROUND

Printed literature is traditionally used for marketing and promotion of products. However, information contained in the printed literature can become outdated quickly. Therefore, the literature must be supplemented or replaced in order to communicate any new information. Also, it is difficult to track the effectiveness of printed literature. For example, it is difficult to determine whether the literature has convinced recipients to purchase a product or which pages of the literature the recipients find useful.

A system for distributing compact discs (“CDs”) containing a digital publication and reporting user interaction with the publication is well known. U.S. Patent Application Publication No. 2002/0107727 (“the '727 publication”) to Traub describes distributing CDs, each containing a digital publication. When using the CD, the user is prompted to enter a unique password that is also distributed to the user for identifying the user. Information relating to the user's interaction with the publication is stored on the user's computer and transmitted to a server over the internet. The information allows advertisers to assess the effectiveness of the publication in order to make changes for future versions of the digital publication.

Although the system of the '727 publication may allow an advertiser to update the digital publication, users must wait until receiving a CD containing a new version of the publication to view updated information. Users must also retain the passwords assigned to them, which is inconvenient. Furthermore, the user interaction information is transmitted at certain time intervals, which creates delays in reporting the information to the advertiser.

The disclosed system is directed to overcoming one or more of the problems set forth above.

### SUMMARY OF THE INVENTION

In one aspect, the present disclosure is directed to a system of marketing using effectiveness metrics including a server hosting an internet application, a database capable of storing information received by the server, and a digital storage medium providing a user interface when inserted into a client device. The user interface includes at least one link to the internet application, a user being directed to the internet application by the link in the user interface and interacting with the internet application using the client device. Information relating to the user is transmitted and stored in the database. The internet application is changed based on an analysis of the transmitted information.

In another aspect, the present disclosure is directed to a method of marketing using effectiveness metrics including hosting an internet application on a server, storing information received by the server in a database, and providing a user interface when a digital storage medium is inserted into a client device. The user interface includes at least one link to the internet application, directing the user to the internet application using the link in the user interface, transmitting information relating to the user to the database, storing the transmitted information in the database, analyzing the transmitted information stored in the database, and changing the internet application based on the analysis of the transmitted information.

In yet another aspect, the present disclosure is directed to a system of marketing using effectiveness metrics including a server hosting an internet application, a database capable of storing information received by the server, a first digital storage medium providing a user interface when inserted into a client device, the user interface including at least one link to the internet application, a user being directed to the internet application by the link in the user interface and interacting with the internet application using the client device, and information relating to the user being transmitted and stored in the database. A distribution method for a second digital storage medium is determined based on an analysis of the transmitted information.

### BRIEF DESCRIPTION OF THE DRAWINGS

FIG. 1 is a schematic diagram illustrating a distribution tree for distributing CDs;

FIG. 2 is a schematic diagram illustrating a system of marketing using effectiveness metrics when an end user interacts with an internet application stored on a remote server according to an exemplary disclosed embodiment;

FIG. 3 is a flow chart illustrating an exemplary disclosed method of marketing using the distribution tree of FIG. 1;

FIG. 4 is a flow chart illustrating a method of creating the CDs, managing and uploading database references, and storing CD information according to an exemplary disclosed embodiment;

FIG. 5 is a flow chart illustrating a method of receiving CD orders, processing and storing dealer information, assigning serial numbers to dealers, and distributing the CDs to the dealers according to an exemplary disclosed embodiment;

FIG. 6 is a flow chart illustrating a method of distributing the CDs to the users and storing distribution method, user, and user activity information according to an exemplary disclosed embodiment; and

FIG. 7 is a flow chart illustrating the method of analyzing data with effectiveness metrics and adjusting an application according to an exemplary disclosed embodiment.

### DETAILED DESCRIPTION

CDs or other types of digital storage media that can be used to distribute digital information, e.g., mini CDs, USB devices, DVDs, memory sticks, memory cards, floppy disks, and e-mail, may be used to promote and market one or more internet applications, which are used to promote and market products. The internet application is created and maintained by one or more application owners.

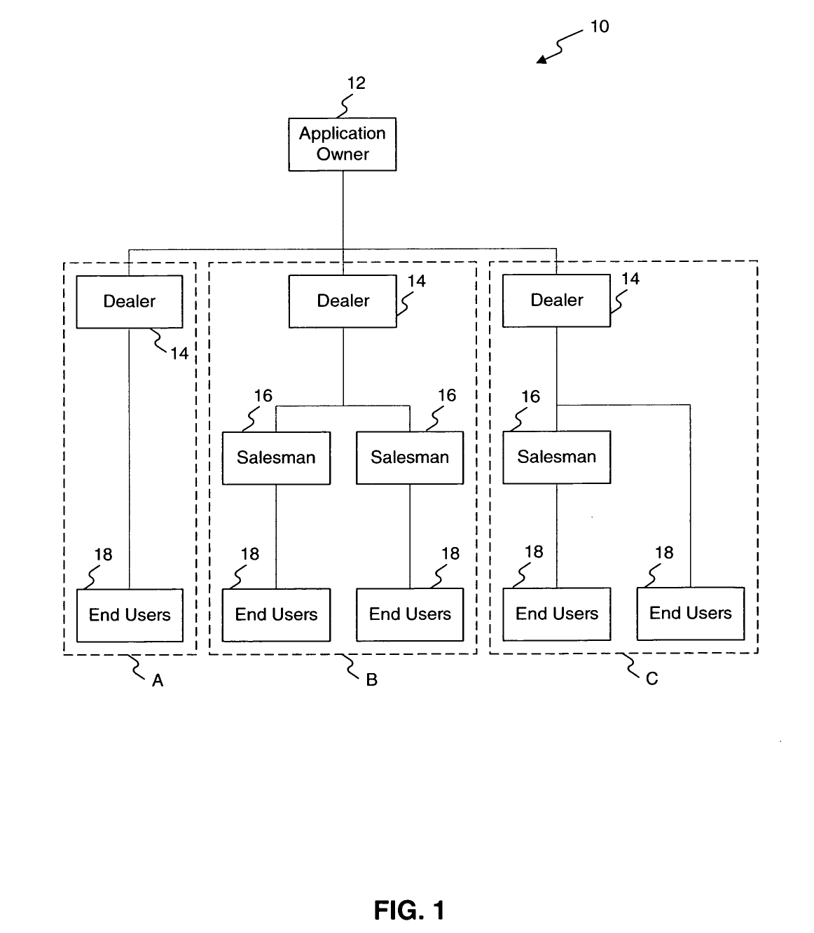

FIG. 1 illustrates an exemplary distribution tree 10 showing how the CDs may be distributed from the application owners 12 to one or more end users 18.

The application owners 12 distribute the CDs to one or more dealers 14. The dealers 14 distribute the CDs to the end users 18 using one or more distribution methods, e.g., mailing list, person-to-person, or trade show.

Areas A-C (shown in FIG. 1 and indicated by dashed lines) show three different ways in which the CDs may be distributed from the application owners 12 to the end users 18. As shown in Area A, the dealers 14 may distribute the CDs directly to end users 18. The end users 18 may be classified as known and unknown users. Known users are identified using a mailing list or other list of end users. Unknown users are “self-identified,” i.e., request a CD at a trade show, person-to-person, online, etc.

Alternatively, as shown in Area B, the dealers 14 may distribute the CDs directly to salesmen 16 (managed users), who then distribute the CDs to the end users 18.

As shown in Area C, the dealers 14 may distribute the CDs directly to a combination of end users 18 and salesmen 16. The salesmen 16 then distribute the CDs to the end users 18 using one or more of the distribution methods.

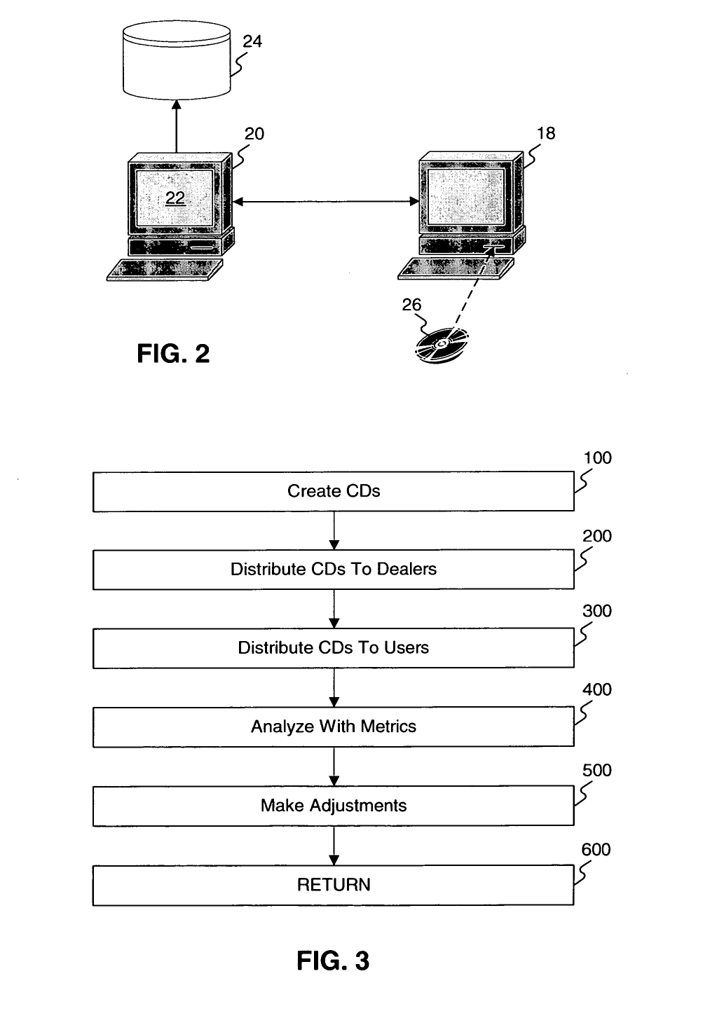

The end user 18 inserts the digital storage medium 26 into a client device that connects to a network, such as a computer, a smart phone, a personal digital assistant (PDA), a Blackberry®, a device that uses Bluetooth®, a wireless device, or other multimedia device. For example, as shown in FIG. 2, the end user 18 may insert the CD 26 into a computer connected to a remote server 20 by means of the internet. The CD stores an executable file, such as an executable file created using Macromedia Flash®, for providing a user interface including, for example, text, pictures, and links. The user interface may also include one or more links that direct the end user 18 to one or more internet applications 22.

The internet applications 22 are stored on the server 20, and the server 20 is connected to a separate database 24. Alternatively, the database 24 may be stored in the server 20. The database 24 receives and stores information relating to the distributed CDs and the marketed applications 22, e.g., distribution method information, marketing message information, and user activity information, which are described below. The information is transmitted to the database 24 in real time from the server 20, and the server 20 may also retrieve the information stored in the database 24.

The internet applications 22 may include, but are not limited to, price quote calculators, product stores, equipment management solutions, and other informational tools. The end users 18 may browse through the information provided in the internet applications 22, provide information to request personalized quotes and solutions, and purchase products. Information relating to this user activity, e.g., pages visited, information requested or viewed, and products purchased may be transmitted from the server 20 to the database 24.

The CD also stores a serial number, which is assigned to each CD when the CDs are created. The serial number uniquely identifies each CD and is stored in the database 24 to allow for tracking information relating to a particular CD and associated end user 18. When information is stored in the database 24, a corresponding serial number is stored with the information in order to properly link the information to a corresponding end user 18.

Each of the internet applications 22 is created by one of the application owners 12. When creating the CDs, each of the application owners 12 may personalize the CDs using a dealer logo or other branded artwork and may personalize the CDs to contain a specific marketing message, such as information or links that point to or highlight certain features of a particular internet application 22, e.g., products, offers, and other areas of the internet application that are predicted to be of particular interest to the users who will be receiving the CDs.

The CDs allow the application owners 12 to communicate one or more of the marketing messages to the end user 18. Examples of marketing messages include a description of and links to specially promoted applications 22, special features of the applications 22, and newsletters or other informational materials. The marketing messages may be incorporated into the user interface of the CD and/or into the applications 22. An advantage of including the marketing message in the application 22 is that the application 22 can be updated to incorporate updated or new information, and the new information can be conveyed to the end users 18 without having to redistribute CDs to the same users. In addition, the application owners 12 can determine whether certain webpages of the applications 22 are more effective than others in conveying the marketing message and can alter the webpages to more effectively convey the marketing message.

Database references are also incorporated into the internet application 22. When the end user 18 interacts with the internet application 22 and the end user 18 reaches a webpage or other area of the application 22 that includes one of the database references, the server 20 transmits user activity information to the database 24 and links the user activity information with the serial number of the CD used by the end user 18. Therefore, when the end user 18 reaches an area of the internet application 22 that includes a database reference, the user activity information is transferred to and stored in the database 24.

The transferred user activity information includes information that is specific to the user's activity and is specified using the database reference. For example, the database reference may indicate that the user activity information includes a location or Uniform Resource Locator (“URL”) of the webpage that is viewed, specific actions that are taken, whether a price quote was requested, or whether a product was purchased. The database references also specify where in the database 24 to store the user activity information, i.e., how to classify the information so that it may be easily retrieved for analysis in the future. The database references, therefore, allow for the information stored in the database 24 to be stored without any user intervention or input.

### INDUSTRIAL APPLICABILITY

The disclosed method and system may be applicable to any system for distributing marketing materials where it is desirable that the marketing message be evaluated using effectiveness metrics. The disclosed method and system of marketing using effectiveness metrics allows for the transfer of information between the user and the server in real time, and does not require the user to remember any passwords. The operation of the system of marketing using effectiveness metrics will now be explained.

FIG. 3 is a flow chart illustrating an exemplary disclosed method of marketing using effectiveness metrics. First, the CDs 26 for promoting one or more of the internet applications 22 are created (Step 100). The CDs 26 are distributed to the dealers 14 (Step 200) and then distributed to the users 18 (Step 300) so that the user 18 may use the CDs 26 to be forwarded to the internet applications 22. During the above mentioned steps, information identifying, for example, the dealer, the salesman, the user, the distribution method, and the user's activity with the application may be stored in the database 24. This information may be analyzed using effectiveness metrics (Step 400), and the results of the metric analysis may be used to make adjustments (Step 500). This process may be repeated (Step 600).

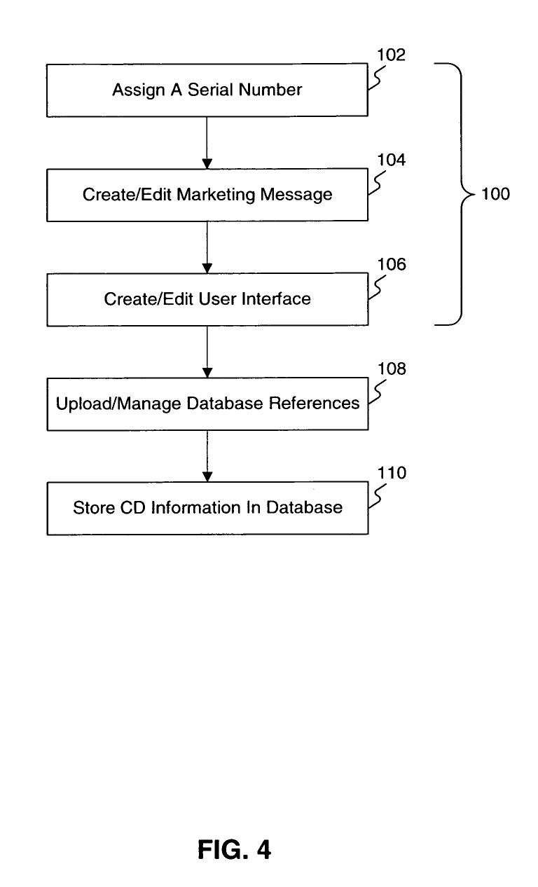

FIG. 4 is a flow chart illustrating an exemplary method of creating the CDs 26, managing and uploading database references, and storing CD information. Each CD 26 is assigned a unique serial number (Step 102). Groups of CDs 26 corresponding to specific ranges of serial numbers may be assigned to each application owner 12, thereby corresponding to particular applications 22.

The marketing message for the CD 26 is created or edited, and included in the internet application 22 and/or the CD 26 (Step 104). The user interface is then created or edited, and stored on the CD 26 (Step 106). The user interface provides the links that direct the user to specific pages and areas of the internet application 22 that present the marketing message that was created or edited in Step 104. Database references are created or edited (“managed”) in the internet application 22 and uploaded to the remote server 20 to allow the database 24 to be updated dynamically when the end user 18 interacts with the internet application 22 (Step 108). CD information is stored in the database 24 (Step 110). The CD information includes the serial number and information identifying the marketing message(s).

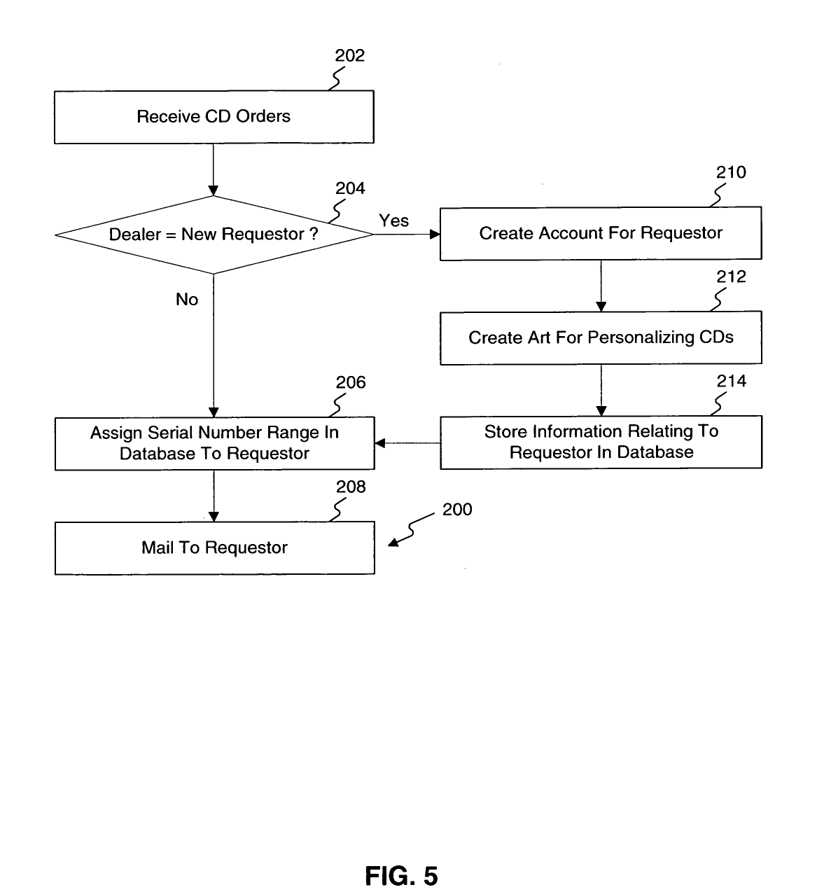

FIG. 5 is a flow chart illustrating an exemplary method of receiving CD orders, processing and storing dealer information, assigning serial numbers to dealers 14, and distributing the CDs 26 to the dealers 14.

The dealers 14 place orders for the CDs 26, and the application owners 12 receive the orders (Step 202). Next, it is determined whether the dealer 14 who has placed the order has requested CDs for the first time (Step 204). If not, then the dealer 14 already has an account established, and information about the dealer 14, e.g., name, is known. A range of serial numbers corresponding to the CDs 26 ordered by the dealer 14 is identified, and the dealer information is linked and stored with the identified serial number range in the database 24 (Step 206). As a result, the database 24 may be used to identify the dealer 14 who distributed any given CD 26. Then, the CDs 26 are mailed to the dealer 14 (Step 208).

If the dealer 14 is requesting CDs 26 for the first time, then an account is created for the dealer 14 by the application owners 12 (Step 210). Personalized art work, such as a dealer logo, is prepared for placement on the CDs 26 (Step 212). Information on the dealer 14 is stored in the database 24 and matched with a range of serial numbers corresponding to the CDs 26 ordered by the dealer 14 (Steps 214 and 206). Then, the CDs 26 are mailed to the dealer 14 (Step 208).

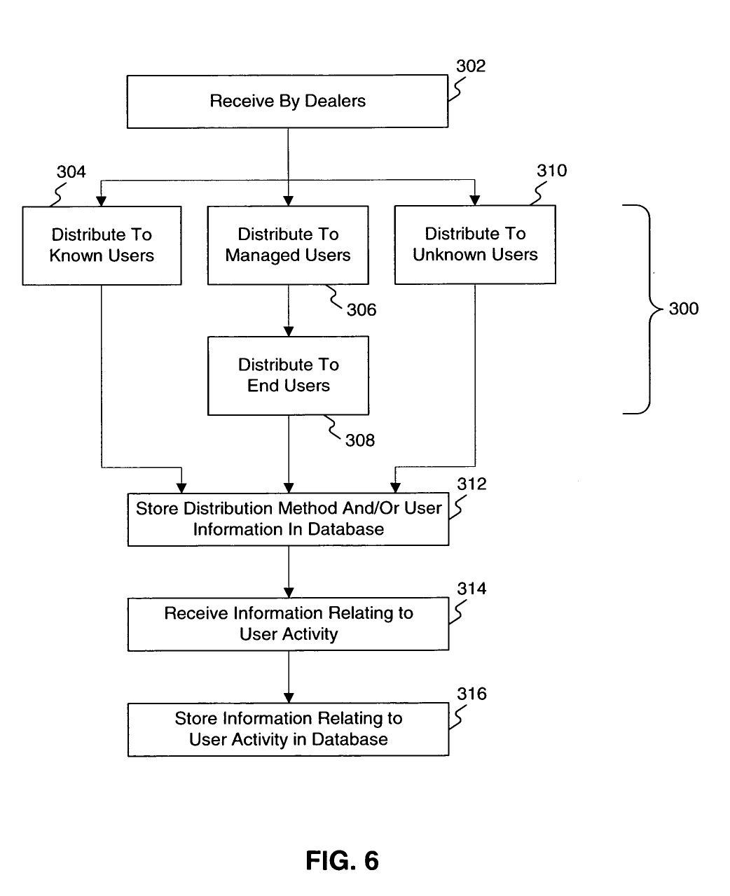

FIG. 6 is a flow chart illustrating an exemplary method of distributing the CDs 26 to the end users 18 and storing distribution method, user, and user activity information.

The CDs 26 that are shipped by the application owners 12 are received by the dealers 14 (Step 302). The CDs 26 are distributed to various end users 18 (Steps 304, 306, 308, 310). As shown in Areas A and C of FIG. 1, the dealers 14 may distribute the CDs 26 directly to end users 18, including known users (Step 304) and unknown users (Step 310). Then, the dealers 14 update the database 24 with the information on the method used for distributing the CDs 26 from the dealers 14 to the end users 18, e.g., mailing list, person-to-person, or trade show (Step 312). The dealers 14 may also update the database 24 with user information, e.g., industry, functional role, name, and e-mail address. The distribution method information and user information are matched with the serial number of the distributed CD 26.

Alternatively, as shown in Area B of FIG. 1, the dealers 14 may distribute the CDs 26 to managed users such as salesmen 16 (Step 306) who then distribute the CDs 26 to the end users 18 (Step 308). In this case, the salesmen 16 have access to the database 24 in order to update the distribution method (the method for distributing the CDs 26 from the salesmen 16 to the end users 18) and/or user information (Step 312). In this way, the salesmen 16 may have a proactive role in storing the distribution method information and/or user information and updating the database 24. A range of serial numbers corresponding to the CDs 26 distributed to each salesman 16 is identified in the database 24, and information on each salesman may be linked and stored with the identified serial number range in the database 24. The database 24 may be used to identify the salesman 16 who distributed any given CD 26.

After distributing the CDs 26 to the end users 18, the end users 18 may insert the CDs 26 into their computers, use the user interface provided by the CDs 26, and access the internet applications 22. As the end users 18 interact with the internet applications 22, the user activity information is transmitted to and received by the database 24 (Step 314). The user activity information is stored in the database 24 and matched with the corresponding serial number of the distributed CD 26 (Step 316).

As shown in FIG. 3, after the CDs 26 are distributed to the end users 18, the information stored in the database 24 is analyzed using metrics (Step 400), and the internet applications 22 may be adjusted by the application owners 12 (Step 500).

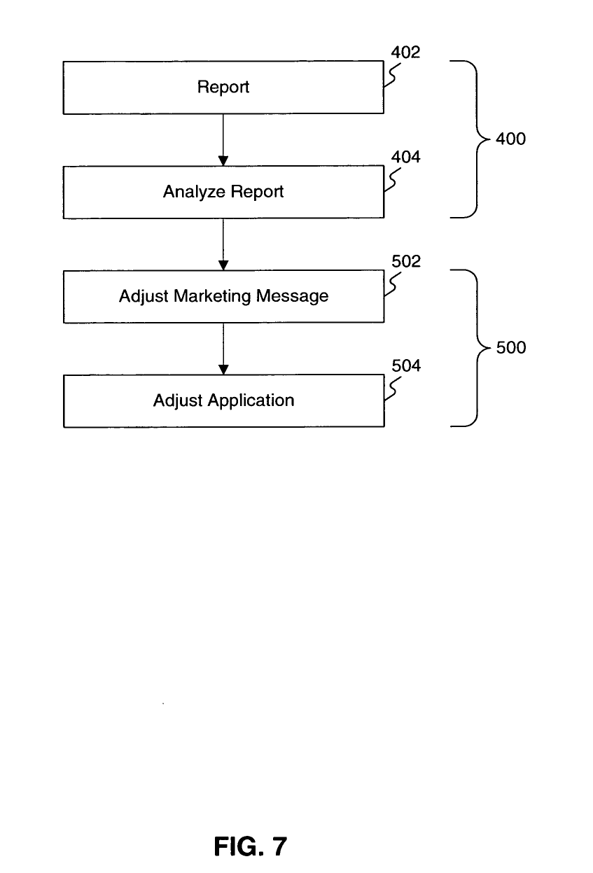

FIG. 7 is a flow chart illustrating the method of analyzing data with the metrics and adjusting the internet application 22. The information collected in the database 24 may be retrieved and viewed using a program such as a browser or a spreadsheet program. One or more reports may be generated based on the information stored in the database 24 (Step 402). The reports may be generated on a regular basis or as requested by the application owners 12. The application owners 12 may analyze the reports using effectiveness metrics (Step 404) and use the results of the metric analysis to make adjustments to the applications 22 (Step 500).

The effectiveness metrics are defined by the application owners 12. Various effectiveness metrics may be used to evaluate the effectiveness of the CDs 26, the marketing messages, and the applications 22 themselves. For example, if an application receives a predetermined minimum number of purchases for a product, the application owner 12 may alter the marketing message to emphasize the particular product.

Effectiveness metrics may also be used to compare applications and features to each other. The applications and features relating to the marketing messages can be improved based on the user activity information stored in the database 24. A report may compare user activity to determine the relative effectiveness for conveying a marketing message. If certain features or webpages are more effective in conveying the marketing message by generating more user activity, the application owners 12 can alter other features or webpages to more effectively convey the marketing message. The application owners 12 may also alter the marketing message to include new information (Step 502).

Another report may compare user activity by application promoted. If a particular application 22 obtains more user activity than another application, then the application owner 12 may adjust the application 22 to resemble the one that obtained more user activity (Step 504).

Another report may compare user activity by industry of the end user 18. If more user activity is generated by users in certain industries, the application owners 12 may alter their target audience to include more users in those industries or in similar industries.

Another report may compare user activity by distribution method. Based on this report, if one method for distributing the CDs generates more user activity, i.e., purchases, visits to the application, webpage views, or requests for price quotes, then the application owner 12 may choose to start relying more on that one distribution method.

At this point, the steps of creating the CDs 26, distributing the CDs 26 to dealers 14, salesmen 16, and end users 18, performing the metric analysis, and making adjustments may be repeated (Step 600). Since the applications and optionally at least a portion of the marketing message are provided on the server 20, the applications 22 may be improved multiple times without having to redistribute new CDs 26 to the end users 18. This increases convenience to the end users 18 and allows updated information to be sent to the end users 18 in real time. As a result, the end users 18 can immediately access the updated information.

The relative effectiveness of each of the distribution methods may be determined so that relatively ineffective distribution methods may be used less frequently or eliminated entirely.

Since the database tracks information based on the serial numbers of the CDs 26, the end users are not required to remember passwords assigned to them. This increases the convenience for the end users.

The method of marketing using effectiveness metrics allows application owners to promote internet applications using a dealer network and allows the application owners to monitor the effectiveness of different aspects of the marketing process, such as the target audience, marketing message, and distribution methods. The disclosed system also allows the application owners to make changes to the marketing process and allows the end users to access updated information in the marketing messages and applications in real time.

It will be apparent to those skilled in the art that various modifications and variations can be made in the disclosed method and system of marketing using effectiveness metrics without departing from the scope or spirit of the disclosure. Other embodiments of the disclosed method and system will be apparent to those skilled in the art from consideration of the specification and practice of the method and system disclosed herein. It is intended that the specification and examples be considered as exemplary only.

1. A system of marketing using effectiveness metrics comprising:
a server hosting an internet application;
a database capable of storing information received by the server;
a digital storage medium providing a user interface when inserted into a client device, the user interface comprising at least one link to the internet application;
a user being directed to the internet application by the link in the user interface and interacting with the internet application using the client device; and
information relating to the user being transmitted and stored in the database, the transmitted information including user activity information, wherein the internet application is changed based on an analysis of the transmitted user activity information.

2. The system of claim 1, further including an identifier assigned to the digital storage medium and stored in the database, wherein the transmitted information stored in the database is linked to the identifier.

3. The system of claim 1, wherein the user is directed to the changed internet application using the link in the user interface provided by the digital storage medium.

4. The system of claim 1, wherein the transmitted user activity information includes information relating to at least one of a purchase, a viewing of a webpage, and a request for a price quote using the internet application.

5. The system of claim 1, wherein:
the transmitted information includes distribution method information stored in the database, the distribution method information identifying how the user received the digital storage medium; and
the analysis determines a distribution method for a second digital storage medium based on the transmitted information.

6. The system of claim 1, wherein:
the transmitted information includes user information stored in the database, the user information identifying at least one of a functional role or an industry of the user; and
the analysis determines a target audience for the second digital storage medium based on the transmitted information.

7. The system of claim 1, further including a dealer who distributes the digital storage medium to the user, wherein the dealer stores at least a portion of the transmitted information in the database.

8. The system of claim 1, further including:
a salesman who distributes the digital storage medium to the user; and
a dealer who distributes the digital storage medium to the salesman, wherein the salesman stores at least a portion of the transmitted information in the database.

9. A method of marketing using effectiveness metrics including:
hosting an internet application on a server;
storing information received by the server in a database;
providing a user interface when a digital storage medium is inserted into a client device, the user interface including at least one link to the internet application;
directing the user to the internet application using the link in the user interface;
transmitting information relating to the user to the database, the transmitted information including user activity information;
storing the transmitted user activity information in the database;
analyzing the transmitted user activity information stored in the database; and
changing the internet application based on the analysis of the transmitted user activity information.

10. The method of claim 9, further including:
assigning an identifier to the digital storage medium;
storing the identifier in the database; and
linking the transmitted information stored in the database to the identifier.

11. The method of claim 9, further including directing the user to the changed internet application using the link in the user interface provided by the same digital storage medium.

12. The method of claim 9, wherein the transmitted user activity information includes information relating to at least one of a purchase, a viewing of a webpage, and a request for a price quote using the internet application.

13. The method of claim 9, wherein:
the transmitted information includes distribution method information, the distribution method information identifying how the user received the digital storage medium; and
the analyzing of the transmitted information includes determining a distribution method for a second digital storage medium based on the transmitted information.

14. The method of claim 13, wherein the determining of the distribution method for the second digital storage medium includes determining which of the distribution methods used for the first digital storage medium generated a highest amount of activity.

15. The method of claim 9, wherein:
the transmitted information includes user information, the user information identifying at least one of a functional role or an industry of the user; and
the analyzing of the transmitted information includes determining a target audience for a second digital storage medium based on the transmitted information.

16. The method of claim 15, wherein the determining of the target audience for the second digital storage medium includes determining which of the users using the first digital storage medium generated a highest amount of activity.

17. The method of claim 9, wherein:
the transmitted information includes marketing message information, the marketing message information identifying at least one of an application promoted, a feature promoted, and an informational material; and
the analyzing of the transmitted information includes determining a marketing message for a second digital storage medium based on the transmitted information.

18. The method of claim 17, wherein the determining of the marketing message for the second digital storage medium includes determining which of the marketing messages provided in the first digital storage medium generated a highest amount of activity.

19. The method of claim 9, further including distributing the digital storage medium to the user using a dealer, wherein the dealer stores at least a portion of the transmitted information in the database.

20. The method of claim 9, further including:
distributing the digital storage medium to the user via a salesman; and
distributing the digital storage medium to the salesman via a dealer, wherein the salesman stores at least a portion of the transmitted information in the database.

21. A system of marketing using effectiveness metrics comprising:
a server hosting an internet application;
a database capable of storing information received by the server;
a first digital storage medium providing a user interface when inserted into a client device, the user interface comprising at least one link to the internet application;
a user being directed to the internet application by the link in the user interface and interacting with the internet application using the client device; and
information relating to the user being transmitted and stored in the database, wherein a distribution method for a second digital storage medium is determined based on an analysis of the transmitted information.

22. The system of claim 21, wherein the transmitted information includes distribution method information, the distribution method information identifying how the user received the first digital storage medium.

23. The system of claim 21, the analysis of the transmitted information determines which of the distribution methods used for the first digital storage medium generated a highest amount of activity.
